(19) United States
(12) Patent Application Publication
(10) Pub. No.: US 2003/0229993 A1
(43) Pub. Date: Dec. 18, 2003

(54) Tube for a trimmer or a clearing saw

(75) Inventor: Ola Agne, Jonkoping (SE)

Correspondence Address: PEARNE & GORDON LLP, 1801 EAST 9TH STREET, SUITE 1200, CLEVELAND, OH, 44114-3108, US

(73) Assignee: Aktiebolaget Electrolux

(21) Appl. No.: 10/459,333

(22) Filed: Jun. 11, 2003

(30) Foreign Application Priority Data
Jun. 13, 2002 (SE) 0201820-8

(51) Int. Cl. B26B 7/00

(52) U.S. Cl. 30/276

(57) ABSTRACT

Arrangement in a tube (10) for engine powered portable tool comprising a drive shaft (12) supported by a bearing (11) placed in the tube (10). The bearing (11) comprises a pipe shaped section (13) surrounded by at least three wings (14) extending outwards from the pipe shaped section (13). The inside of the tube (10) is provided with at least one protruding flange (15) in contact with the outer end of one of the wings (14) in order to prevent the bearing (11) from rotating inside the tube (10).

Engine powered hand tools are frequently used in order to facilitate work in gardens, parks and forests. There are a number of different types of tools, like for example trimmers, clearing saws, hedge trimmers and saws for pruning of trees. The size of the tools is selected so that they are optimized for the work that the tool is intended to do. This means that the smallest ones are hand held while bigger tools are carried in an ergonomic harness.

One embodiment of these types of tools is a tool where the engine and the related components are placed in one end of a tube while the working tool is placed in the other end of the tube. It is possible to provide the tool with different types of working tools and the length of the tube is adapted to the work that the tool is intended for. For example is the tube length on a grass trimmer selected so that it is possible for the operator to walk upright and having the working tool at a appropriate height over the ground while a tool for pruning of trees is provided with a longer tube so that it is possible for the operator to reach the different parts of the tree crown from his position on the ground.

The engine is, like already described, placed in one end of the tube while the working tool is placed in the other en of the tube. A drive shaft is extending from the engine in a bearing placed inside the tube in order to reduce vibrations and the amount of noise generated by the drive shaft in the tube.

The drive shaft is made of a shaft, a wire or a stiff line made of metal or a plastic material. A star shaped bearing provided with wings extending in radial direction outwards from a pipe shaped section that surrounds the drive shaft supports the drive shaft. The bearing is placed in the tube so that the wings are in contact with the circular inside of the tube to keep the pipe shaped section in the centre of the tube. The bearing is either made of a long section extending through the entire tube or shorter sections placed at selected positions along the tube. The bearing is kept at the selected position by grip fitting between the inside surface of the tube and the bearing.

These types of tools are used for a lot of different types of work all around the world where the surrounding conditions vary a lot. Big changes in the surrounding conditions, like for example changing temperatures and the use of the tool for different kinds of work, sometimes makes the bearing shrink so that the diameter of the bearing is reduced. The smaller diameter reduces or eliminates the grip fitting between the bearing and the tube. When this happens is it possible for the bearing to start rotating inside the tube because of the rotating drive shaft. The bearing either rotates in the same direction as the drive shaft or in the opposite direction. A rotating bearing will have several negative consequences like increased temperature, more vibrations, higher amount of generated noise as well as increased wear on the components in the tool. All these negative consequences increase the risk for breakdowns of some of the components in the tool or the entire tool.

In this patent application is an effective solution to the problem described above illustrated and described.

The problem is solved by providing the inside of the tube with protruding sections that will keep the bearing in the selected position inside the tube and prevent the bearing from starting to rotate in relation to the tube.

The protruding sections could have different shapes but all embodiments include one or more protruding flanges that extend in axial direction along the inside of the circular tube. The protruding flanges acts as support for the wings extending in radial direction from the centre of the bearing. The wings support the bearing and the drive shaft in the tube. The flanges are for example positioned on one side of each of the wings of the bearing so that the bearing is kept in the right position in the tube. However, the preferred solution is to place one flange on each side of each wing so that the bearing is prevented from rotating in both directions. A less complicated embodiment of the invention is to provide only one or a few of the wings with a support flange or support flanges. The height of the flanges in relation to the inside of the tube could be different for different embodiments of the invention but never exceed the length of the wings that are supporting the centre of the bearing and the drive shaft inside the tube.

If the tube is provided with support flanges on both sides of one or more wings is it possible to press the flanges together so that the wing is fastened between the flanges. This is done at selected positions a long the tube so that the bearing also is secured in axial direction in the tube.

The tube and the support flanges are normally made of a metal or plastic material but other materials are also possible, for example a fiber composite material.

The cross section of the support flanges is preferably rectangular, square, and triangular or half cylindrical but other cross sections are also possible. The edges of the flanges as well as the corners where the flange are in contact with the inside of the tube are normally rounded in order to increase the strength of the flange and to make it easier to produce the tube.

A number of different embodiments of the claimed invention are illustrated in the drawings.

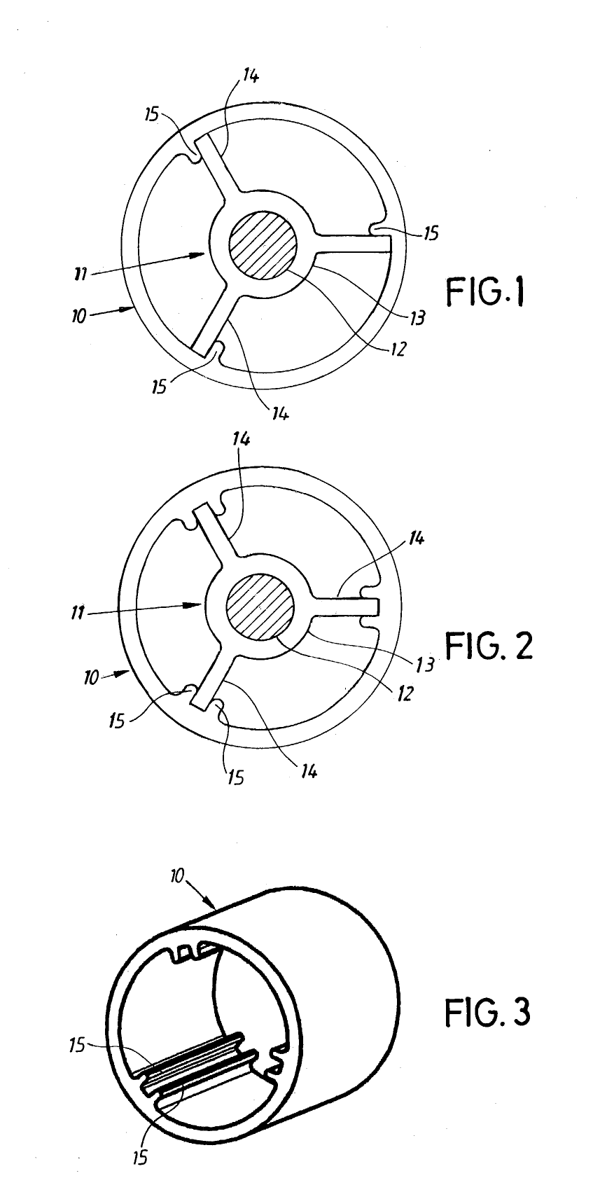

FIG. 1. Illustrates the tube, the bearing, the drive shaft and a first embodiment of the claimed invention.

FIG. 2. Illustrates a second embodiment of the claimed invention.

FIG. 3. Illustrates a perspective view of the tube and the flanges extending along the inside of the tube.

In FIG. 1 is a tube 10 for a portable engine powered tool illustrated. Inside the tube 10 is a bearing 11 for support of a drive shaft 12 placed. The drive shaft 12 extend through the entire tube 10 in order to transfer the power from the engine placed in one end of the tube 10 to a working tool placed in the other end of the tube 10. The centre of the bearing 11 consists of a pipe shaped section 13 that surrounds the drive shaft 12. At least three wings 14 extends in radial direction outwards from the pipe shaped section 13 to support the pipe shaped section 13 and the drive shaft 12 so that they are kept in the right position inside the tube 10. In order to prevent the bearing 12 from rotating together with the drive shaft 12 inside the tube 10 is the inside surface of the tube 10 provided with a number of protruding flanges 15 placed so that they are in contact with one side of the outer end of the wings 14.

In FIG. 2 is a second embodiment of the claimed protruding flanges 15 illustrated. The tube 10 is provided with protruding flanges 15 on each side of the outer end of the wings 14 to prevent the bearing 11 from rotating in both directions of rotation for the drive shaft 12.

FIG. 3 illustrates the protruding flanges 15 extending along the inside surface of the tube 10.

1. Arrangement in a tube (10) for engine powered portable tool comprising a drive shaft (12) supported by a bearing (11) placed in the tube (10), said bearing (11) comprising a pipe shaped section (13) surrounded by at least three wings (14) extending outwards from the pipe shaped section (13), characterized in that the inside of the tube (10) is provided with at least one protruding flange (15) in contact with the outer end of one of the wings (14) in order to prevent the bearing ( 1) from rotating inside the tube (10).

2. Arrangement in a tube according to claim 1, characterized in that the wings (14) extend in radial direction outwards from the pipe shaped section (13) and that said wings are supporting the bearing (11) and the drive shaft (12) in the tube (10).

3. Arrangement in a tube according to claim 2, characterized in that the protruding flange or flanges (15) are placed so that they are in contact with the outer end of the wings (14).

4. Arrangement in a tube according to claim 3, characterized in that the numbers of protruding flanges (15) are the same as the numbers of wings (14) on the bearing (11).

5. Arrangement in a tube according to claim 3, characterized in that protruding flanges (15) are placed on both sides of the wings (14) so that the bearing (11) is prevented from rotating in both directions of rotation.

6. Arrangement in a tube according to any of the previous claims, characterized in that the protruding flanges (15) are extending in the axial direction of the tube (10).

7. Arrangement in a tube according to any of the previous claims, characterized in that the protruding flange or flanges (15) either extends along the entire length of the tube (10) or are divided into shorter sections positioned at selected places along the inside of the tube (10).

8. Arrangement in a tube according to any of the previous claims, characterized in that the tube (10) and the protruding flanges (15) are made of a metal, a plastic material or a fiber composite.

9. Arrangement in a tube according to any of the previous claims, characterized in that the cross section of the protruding flanges (15) is rectangular, square, triangular or half cylindrical and that the edges are rounded.

10. Arrangement in a tube according to any of claim 2-5, characterized in that the height of the protruding flanges (15) in relation to the inside of the tube (10) not exceed the length of the wings (14).
